(19) United States
(12) Patent Application Publication
(10) Pub. No.: US 2020/0288447 A1
(43) Pub. Date: Sep. 10, 2020

(54) RESOURCE CONFIGURATION METHOD AND DEVICE

(71) Applicant: GUANGDONG OPPO MOBILE TELECOMMUNICATIONS CORP., LTD., Dongguan (CN)

(72) Inventor: Jia Shen, Dongguan (CN)

(21) Appl. No.: 16/879,617

(22) Filed: May 20, 2020

Related U.S. Application Data
(63) Continuation of application No. PCT/CN2018/072217, filed on Jan. 11, 2018.

(51) Int. Cl. H04W 72/04

(52) U.S. Cl. CPC H04W 72/042; H04W 72/044

(57) ABSTRACT

Embodiments of the present disclosure provide a communication method in a wireless communication network. A device of the network obtains resource configuration information, wherein the resource configuration information indicates resource mapping relationships between M bandwidth parts (BWP) sand N control resource sets, where M and N are positive integers. Then the device monitors, based on the resource mapping relationships, a physical downlink control channel (PDCCH) at least one control resource set corresponding to a target BWP used by the terminal device.

### CROSS-REFERENCE TO RELATED APPLICATION

This application is continuation of International Application No. PCT/CN2018/072217, filed on Jan. 11, 2018, which is hereby incorporated by reference in its entirety.

### BACKGROUND

Embodiments of the present disclosure relate to the field of communications, and more specifically, to a resource configuration method and device.

In a 5G system, a physical downlink control channel (PDCCH) is transmitted in a control resource set (CORESET). Moreover, a system bandwidth in the 5G system may be divided into a plurality of bandwidth parts (BWPs), and a terminal device may use different BWPs according to an indication of a network device. frequency-domain

### SUMMARY

Embodiments of this disclosure provide a resource configuration method and device to flexibly transmit a PDCCH over different frequency-domain resources and improve transmission efficiency.

According to a first aspect, a resource configuration method is provided, including: receiving, by a terminal device, resource configuration information transmitted by a network device, where the resource configuration information is used to indicate resource mapping relationships between M bandwidth parts (BWPs) and N control resource sets, and M and N are positive integers; and monitoring, by the terminal device, based on the resource mapping relationships, a physical downlink control channel (PDCCH) transmitted by the network device over at least one control resource set corresponding to a target BWP used by the terminal device.

Therefore, when dynamic switching occurs between a plurality of BWPs used by the terminal device, the network device may transmit the PDCCH by using different control resource sets. Accordingly, the terminal device monitors the PDCCH over a control resource set corresponding to a currently used BWP, thereby enabling flexible transmission of the PDCCH over different frequency-domain resources, improving transmission efficiency, and reducing power consumption of the terminal device.

In a possible implementation, the resource configuration information includes configuration information of each of the M BWPs, and configuration information of the i^{th} BWP in the M BWPs includes information about the i^{th} BWP and information about at least one control resource set corresponding to the i^{th} BWP, where i ranges from 0 to M−1.

In this embodiment, because the configuration information of each BWP carries the information about the control resource set corresponding to the BWP, it is unnecessary to separately indicate the control resource set and a resource mapping relationship between the control resource set and the BWP, thereby saving signaling overheads and helping the terminal device to quickly determine at least one control resource set corresponding to each BWP.

In a possible implementation, before the monitoring, by the terminal device, a PDCCH transmitted by the network device, the method further includes: obtaining, by the terminal device, from configuration information of the target BWP, information about the at least one control resource set corresponding to the target BWP.

In a possible implementation, information about each control resource set of the at least one control resource set corresponding to the i^{th} BWP includes information about a frequency-domain resource allocated to each control resource set in the i^{th} BWP.

In a possible implementation, the information about each control resource set of the at least one control resource set corresponding to the i^{th} BWP further includes information about a time-domain resource that is located in each control resource set and used to monitor the PDCCH.

In a possible implementation, the information about the time-domain resource includes information about a slot or symbol that is used to monitor the PDCCH.

In a possible implementation, the resource configuration information includes configuration information of each of the M BWPs and configuration information of each of the N control resource sets, where configuration information of the i^{th} BWP in the M BWPs includes information about the i^{th} BWP, and configuration information of the j^{th} control resource set in the N control resource sets includes information about the j^{th} control resource set and an index of a BWP corresponding to the j^{th} control resource set, where i ranges from 0 to M−1, and j ranges from 0 to N−1.

In this embodiment, the configuration information of the CORESET and the configuration information of the BWP are indicated by independent fields, and an index of a BWP corresponding to each CORESET is added to the configuration information of the CORESET. Compared with Form 1, this embodiment can configure the CORESET more flexibly.

In a possible implementation, before the monitoring, by the terminal device, a PDCCH transmitted by the network device, the method further includes: selecting, by the terminal device, from the configuration information of the N control resource sets, at least one piece of configuration information that carries an index of the target BWP, and obtaining, from the at least one piece of configuration information that carries the index of the target BWP, information about the at least one control resource set corresponding to the target BWP.

In a possible implementation, the information about the j^{th} control resource set includes information about a frequency-domain resource allocated to the j^{th} control resource set in the BWP corresponding to the j^{th} control resource set.

In a possible implementation, the information about the j^{th} control resource set further includes information about a time-domain resource that is located in the j^{th} control resource set and used to monitor the PDCCH.

In a possible implementation, the information about the time-domain resource includes information about a slot or symbol that is used to monitor the PDCCH.

According to a second aspect, a resource configuration method is provided, including transmitting, by a network device, resource configuration information to a terminal device, where the resource configuration information is used to indicate resource mapping relationships between M bandwidth parts (BWPs) and N control resource sets, and M and N are positive integers.

Therefore, when dynamic switching occurs between a plurality of BWPs used by the terminal device, the network device may transmit the PDCCH by using different control resource sets. Accordingly, the terminal device monitors the PDCCH over a control resource set corresponding to a currently used BWP, thereby enabling flexible transmission of the PDCCH over different frequency-domain resources, improving transmission efficiency, and reducing power consumption of the terminal device.

In a possible implementation, the method further includes transmitting, by the network device, a physical downlink control channel (PDCCH) to the terminal device over at least one control resource set corresponding to a target BWP used by the terminal device.

In a possible implementation, the resource configuration information includes configuration information of each of the M BWPs, and configuration information of the i^{th} BWP in the M BWPs includes information about the i^{th} BWP and information about at least one control resource set corresponding to the i^{th} BWP, where i ranges from 0 to M−1.

In a possible implementation, information about each control resource set of the at least one control resource set corresponding to the i^{th} BWP includes information about a frequency-domain resource allocated to each control resource set in the i^{th} BWP.

In a possible implementation, the information about each control resource set of the at least one control resource set corresponding to the i^{th} BWP further includes information about a time-domain resource that is located in each control resource set and used to transmit the PDCCH.

In a possible implementation, the information about the time-domain resource includes information about a slot or symbol that is used to transmit the PDCCH.

In a possible implementation, the resource configuration information includes configuration information of each of the M BWPs and configuration information of each of the N control resource sets, where configuration information of the i^{th} BWP in the M BWPs includes information about the i^{th} BWP, and configuration information of the j^{th} control resource set in the N control resource sets includes information about the j^{th} control resource set and an index of a BWP corresponding to the j^{th} control resource set, where i ranges from 0 to M−1, and j ranges from 0 to N−1.

In a possible implementation, the information about the j^{th} control resource set includes information about a frequency-domain resource allocated to the j^{th} control resource set in the BWP corresponding to the j^{th} control resource set.

In a possible implementation, the information about the j^{th} control resource set further includes information about a time-domain resource that is located in the j^{th} control resource set and used to transmit the PDCCH.

In a possible implementation, the information about the time-domain resource includes information about a slot or symbol that is used to transmit the PDCCH.

According to a third aspect, a terminal device is provided. The terminal device can perform operations of the terminal device in the first aspect or any optional implementation of the first aspect. Specifically, the terminal device may include a module unit that is used to perform the operations of the terminal device in the first aspect or any possible implementation of the first aspect.

According to a fourth aspect, a network device is provided. The network device can perform operations of the network device in the second aspect or any optional implementation of the second aspect. Specifically, the network device may include a module unit that is used to perform the operations of the network device in the second aspect or any possible implementation of the second aspect.

According to a fifth aspect, a terminal device is provided. The terminal device includes a processor, a transceiver, and a memory. The processor, the transceiver, and the memory communicate with each other through an internal connection path. The memory is configured to store an instruction, and the processor is configured to execute the instruction stored in the memory. When the processor executes the instruction stored in the memory, the terminal device is enabled to perform the method in the first aspect or in any possible implementation of the first aspect, or the terminal device is enabled to implement the terminal device according to the third aspect.

According to a sixth aspect, a network device is provided. The network device includes a processor, a transceiver, and a memory. The processor, the transceiver, and the memory communicate with each other through an internal connection path. The memory is configured to store an instruction, and the processor is configured to execute the instruction stored in the memory. When the processor executes the instruction stored in the memory, the network device is enabled to perform the method in the second aspect or in any possible implementation of the second aspect, or the network device is enabled to implement the network device according to the fourth aspect.

According to a seventh aspect, a system chip is provided. The system chip includes an input interface, an output interface, a processor, and a memory. The processor is configured to execute an instruction stored in the memory. When the instruction is executed, the processor is enabled to implement the method according to the first aspect or any possible implementation of the first aspect.

According to an eighth aspect, a system chip is provided. The system chip includes an input interface, an output interface, a processor, and a memory. The processor is configured to execute an instruction stored in the memory. When the instruction is executed, the processor is enabled to implement the method according to the second aspect or any possible implementation of the second aspect.

According to a ninth aspect, a computer program product including an instruction is provided. When the computer program product is run on a computer, the computer is enabled to perform the method according to the first aspect or any possible implementation of the first aspect.

According to a tenth aspect, a computer program product including an instruction is provided. When the computer program product is run on a computer, the computer is enabled to perform the method according to the second aspect or any possible implementation of the second aspect.

### BRIEF DESCRIPTION OF THE DRAWINGS

FIG. 1 is a schematic diagram of a wireless communications system according to an embodiment of this disclosure;

FIG. 2 is an interaction flowchart of a resource configuration method according to an embodiment of the present disclosure;

FIG. 3 is a schematic diagram of a BWP and a CORESET according to an embodiment of the present disclosure;

FIG. 4 is a schematic diagram of a BWP and a CORESET according to an embodiment of the present disclosure;

FIG. 5 is a schematic block diagram of a terminal device according to an embodiment of the present disclosure;

FIG. 6 is a schematic block diagram of a network device according to an embodiment of the present disclosure;

FIG. 7 is a schematic structural diagram of a communications device according to an embodiment of the present disclosure; and

FIG. 8 is a schematic structural diagram of a system chip according to an embodiment of the present disclosure.

### DETAILED DESCRIPTION

The technical solutions of the embodiments of this disclosure may be applied to various communications systems, such as a Global System for Mobile Communications (“GSM” for short), a Code Division Multiple Access (“CDMA” for short) system, a Wideband Code Division Multiple Access (“WCDMA” for short), a General Packet Radio Service (“GPRS” for short), a Long Term Evolution (“LTE” for short) system, an LTE Frequency Division Duplex (“FDD” for short) system, an LTE Time Division Duplex (“TDD” for short) system, a Universal Mobile Telecommunications System (“UMTS” for short) system, a Worldwide Interoperability for Microwave Access (“WiMAX” for short) communications system, and a Fifth Generation (“5G” for short) communications system, as well as future communication systems including future implementations or variations of 5G.

More particularly, certain embodiments of the present disclosure relate to how to flexibly transmit the PDCCH in different frequency-domain resources and improve transmission efficiency.

FIG. 1 shows a wireless communications system 100 to which an embodiment of this disclosure is applied. The wireless communications system 100 may include a network device 110. The network device 110 may be a device that communicates with a terminal device. The network device 110 may provide communication coverage for a particular geographic area and may communicate with a terminal device (such as a user equipment (UE), mobile station (MS), or smart phone) located within the coverage area. Optionally, the network device 110 may be a base transceiver station (BTS) in a GSM system or a CDMA system, or may be a NodeB (NB) in a WCDMA system, or may be an evolved Node B (eNB or eNodeB) in an LTE system, a wireless controller in a cloud radio access network (CRAN), a relay station, an access point, an in-vehicle device, a wearable device, a network-side device in a future 5G network, or a network device in a future evolved public land mobile network (PLMN) or the like.

The wireless communications system 100 further includes at least one terminal device 120 located within the coverage of the network device 110. The terminal device 120 may be mobile or fixed. Optionally, the terminal device 120 may be an access terminal, user equipment (UE), a subscriber unit, a subscriber station, a mobile station, a mobile console, a remote station, a remote terminal, a mobile device, a user terminal, a terminal, a wireless communications device, a user agent, or a user apparatus. The access terminal may be a cellular phone, a cordless phone, a Session Initiation Protocol (SIP) phone, a wireless local loop (WLL) station, a personal digital assistant (PDA), a handheld device having a wireless communication function (for example, a tablet computer), a computing device, another processing device connected to a wireless modem, an in-vehicle device, a wearable device, a terminal device in a future 5G network, a terminal device in a future evolved PLMN, or the like.

Optionally, device to device (D2D) communication may be performed between terminal devices 120.

Optionally, the 5G system or network may also be referred to as a new radio (NR) system or network.

FIG. 1 illustrates one network device and two terminal devices. Optionally, the wireless communications system 100 may include a plurality of network devices, and another quantity of terminal devices may be included in the coverage of each network device. This is not limited in this embodiment of this disclosure.

Optionally, the wireless communications system 100 may further include other network entities such as a network controller and a mobility management entity. This is not limited in this embodiment of this disclosure.

In the NR system, a system bandwidth may be divided into a plurality of bandwidth parts (BWPs) (or referred to as transmission bandwidth or the like). The network device may indicate to the terminal device the BWP used by the terminal device, and the terminal device may use different BWPs to transmit data. If a PDCCH is still monitored by using a fixed CORESET configured by the network device, the transmission efficiency of the PDCCH is reduced, and the power consumption of the terminal device is increased.

In this embodiment of this disclosure, the CORESET for transmitting the PDCCH in different BWPs may be flexibly configured. When the terminal device uses different BWPs, the network device transmits the PDCCH by using at least one CORESET configured for the BWP. The terminal device monitors the PDCCH over the at least one CORESET configured for the BWP, thereby flexibly transmitting the PDCCH over different frequency-domain resources, improving transmission efficiency, and reducing power consumption of the terminal device.

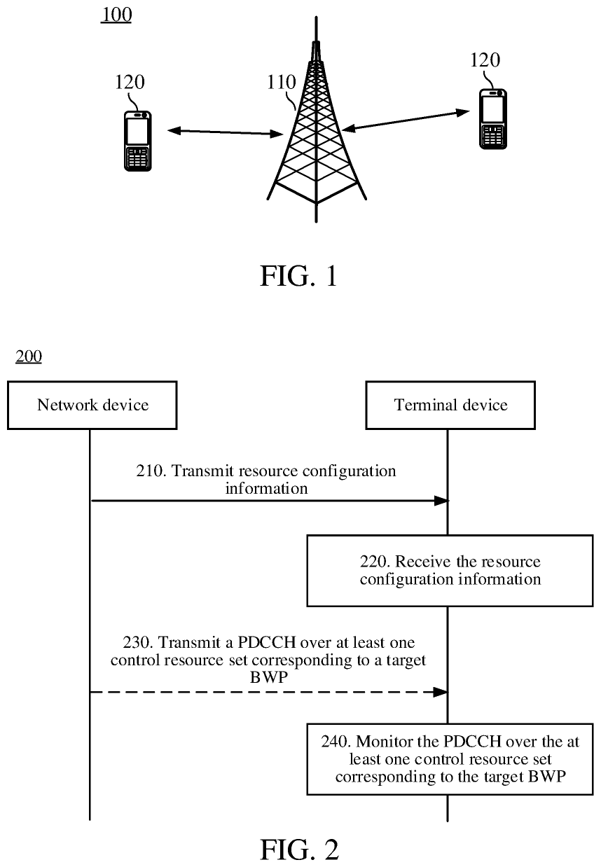

FIG. 2 is an interaction flowchart of a resource configuration method according to an embodiment of this disclosure. A network device shown in FIG. 2 may be, for example, the network device 110 shown in FIG. 1, and a terminal device shown in FIG. 2 may be, for example, the terminal device 120 shown in FIG. 1. As shown in FIG. 2, the resource configuration method includes the following steps.

In step 210, the network device transmits resource configuration information to the terminal device.

In step 220, the terminal device receives the resource configuration information transmitted by the network device.

The resource configuration information is used to indicate resource mapping relationships between M BWPs and N control resource sets, where M and N are positive integers.

Optionally, after step 220, the method further includes step 230.

In step 230, the network device transmits a PDCCH to the terminal device over at least one control resource set corresponding to a target BWP used by the terminal device.

In step 240, the terminal device monitors, based on the resource mapping relationships, the PDCCH transmitted by the network device over at least one control resource set corresponding to the target BWP used by the terminal device.

In the resource mapping relationships, each BWP may correspond to at least one control resource set, and at least one control resource set corresponding to any two different BWPs may be identical, partially identical, or different.

Therefore, when dynamic switching occurs between a plurality of BWPs used by the terminal device, the network device may transmit the PDCCH by using different control resource sets. The terminal device monitors (or listens to, intercepts, detects, or the like) the PDCCH over a control resource set corresponding to a currently used BWP, thereby enabling flexible transmission of the PDCCH over different frequency-domain resources, improving transmission efficiency, and reducing power consumption of the terminal device.

The resource mapping relationships may be determined by the network device and configured for the terminal device based on the resource configuration information, or may be pre-arranged (for example, specified in a protocol) between the network device and the terminal device.

In this embodiment of this disclosure, the resource configuration information used to indicate the resource mapping relationships may have two forms described below.

### Form 1

Optionally, the resource configuration information includes configuration information of each of the M BWPs. Configuration information of the i^{th} BWP in the M BWPs includes information about the i^{th} BWP and information about at least one control resource set corresponding to the i^{th} BWP, where i ranges from 0 to M−1 (i traverses 0 to M−1).

The configuration information of the M BWPs may be carried in M independent fields, respectively. The configuration information of each BWP is carried in a dedicated continuous field of the configuration information of each BWP, and the dedicated field of the configuration information of each BWP carries information about a CORESET corresponding to the BWP. Therefore, the configuration information of each BWP includes not only information about the BWP itself but also information about at least one control resource set corresponding to the BWP. The field herein may also be referred to as a sequence, a field, an information field, or the like.

For example, the configuration information of the i^{th} BWP may carry some information related to the i^{th} BWP, such as parameter information, resource location information, PDCCH information, physical downlink shared channel (PDSCH) information, and physical random access channel (RACH) information. In this embodiment, the configuration information of the i^{th} BWP includes not only such information, but also the information about the at least one control resource set corresponding to the i^{th} BWP. The information about the at least one control resource set corresponding to the i^{th} BWP is subordinate to the configuration information of the BWP and is carried in a part of a dedicated field of the configuration information of the BWP. When receiving the resource configuration information, the terminal device may obtain, from the configuration information of each BWP, the information about the BWP itself and the information about the at least one control resource set corresponding to the BWP.

When the terminal device currently uses the target BWP for data transmission, the network device transmits the PDCCH to the terminal device over the at least one control resource set corresponding to the target BWP. Correspondingly, the terminal device detects, over the at least one control resource set corresponding to the target BWP used by the terminal device, the PDCCH transmitted by the network device.

Optionally, information about each control resource set of the at least one control resource set, which is carried in the configuration information of the i^{th} BWP, includes information about a frequency-domain resource allocated to each control resource set in the i^{th} BWP.

Further, optionally, the information about each control resource set of the at least one control resource set corresponding to the i^{th} BWP may further include information about a time-domain resource (also referred to as a search space) that is located in each control resource set and used to monitor the PDCCH, for example, information about a slot or symbol that is used to monitor the PDCCH.

When the resource configuration information indicates the resource mapping relationship between the BWP and the control resource set by means of Form 1, optionally, before step 240, the terminal device may obtain, from the configuration information of the target BWP, the information about the at least one control resource set corresponding to the target BWP.

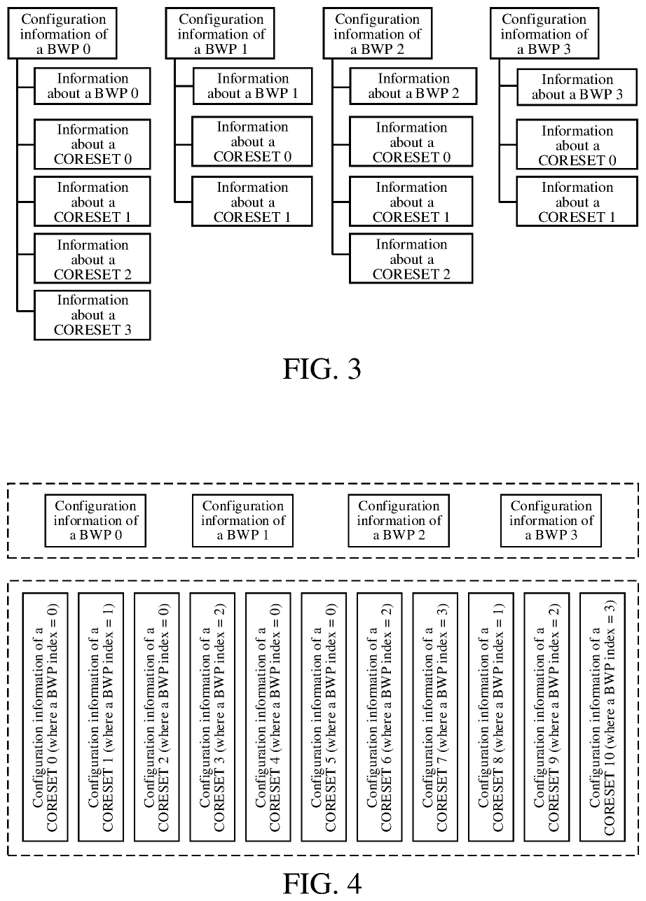

For example, as shown in the schematic diagram of the BWP and the CORESET in FIG. 3, the resource configuration information includes configuration information of M BWPs. It is assumed that M=4. Configuration information of a BWP 0 includes information about the BWP 0 and information about at least one CORESET (a CORESET 0, a CORESET 1, a CORESET 2, and a CORESET 3) corresponding to the BWP 0, where information about each CORESET includes information about a frequency-domain resource allocated to the CORESET in the BWP 0. Configuration information of a BWP 1 includes information about the BWP 1 and information about at least one CORESET (the CORESET 0 and the CORESET 1) corresponding to the BWP 1, where information about each CORESET includes information about a frequency-domain resource allocated to the CORESET in the BWP 1. Configuration information of a BWP 2 includes information about the BWP 2 and information about at least one CORESET (the CORESET 0, the CORESET 1 and the CORESET 2) corresponding to the BWP 2, where information about each CORESET includes information about a frequency-domain resource allocated to the CORESET in the BWP 2. Configuration information of a BWP 3 includes information about the BWP 3 and information about at least one CORESET (the CORESET 0 and the CORESET 1) corresponding to the BWP 3, where information about each CORESET includes information about a frequency-domain resource allocated to the CORESET in the BWP 4.

In FIG. 3, the configuration information of each BWP carries the information about the BWP and information about at least one CORESET corresponding to the BWP. Configuration information of different BWPs may be carried in different fields, and the fields are independent of each other without overlapping.

If the target BWP currently used by the terminal device is a BWP 0, the network device transmits the PDCCH over at least one CORESET corresponding to the BWP 0. Correspondingly, the terminal device directly obtains, from the configuration information of the BWP 0, information about the at least one CORESET corresponding to the BWP 0, and monitors, in the at least one CORESET, the PDCCH transmitted by the network device. If the target BWP currently used by the terminal device is a BWP 1, the network device transmits the PDCCH over at least one CORESET corresponding to the BWP 1. Correspondingly, the terminal device directly obtains, from the configuration information of the BWP 1, information about the at least one CORESET corresponding to the BWP 1, and monitors, in the at least one CORESET, the PDCCH transmitted by the network device. If the target BWP currently used by the terminal device is a BWP 2, the network device transmits the PDCCH over at least one CORESET corresponding to the BWP 2. Correspondingly, the terminal device directly obtains, from the configuration information of the BWP 2, information about the at least one CORESET corresponding to the BWP 2, and monitors, in the at least one CORESET, the PDCCH transmitted by the network device. If the target BWP currently used by the terminal device is a BWP 3, the network device transmits the PDCCH over at least one CORESET corresponding to the BWP 3. Correspondingly, the terminal device directly obtains, from the configuration information of the BWP 3, information about the at least one CORESET corresponding to the BWP 3, and monitors, in the at least one CORESET, the PDCCH transmitted by the network device.

In this embodiment, because the configuration information of each BWP carries the information about the control resource set corresponding to the BWP, it is unnecessary to separately indicate the control resource set and a resource mapping relationship between the control resource set and the BWP, thereby saving signaling overheads and helping the terminal device to quickly determine at least one control resource set corresponding to each BWP.

Form 2

Optionally, the resource configuration information includes configuration information of each of the M BWPs and configuration information of each of the N control resource sets. Configuration information of the i^{th} BWP in the M BWPs includes information about the i^{th} BWP, and configuration information of the j^{th} control resource set in the N control resource sets includes information about the j^{th} control resource set, and an index of a BWP corresponding to the j^{th} control resource set, where i ranges from 0 to M−1, and j ranges from 0 to N−1.

Specifically, the resource configuration information includes configuration information of M BWPs and configuration information of N control resource sets. The configuration information of the M BWPs may be carried in M independent fields, respectively. The configuration information of the N control resource sets also is carried in N independent fields, respectively, and the configuration information of each control resource set is carried in a dedicated continuous field of the configuration information of each control resource set. The configuration information of each BWP in the resource configuration information includes the information about the BWP, and the configuration information of each control resource set in the resource configuration information includes the information about the control resource set and an index of a BWP to which the control resource set belongs. The field herein may also be referred to as a sequence, a field, an information field, or the like.

For example, the configuration information of the j^{th} control resource set in the N control resource sets includes information about the j^{th} control resource set, for example, information about a frequency-domain resource allocated to the j^{th} control resource set in a BWP corresponding to the j^{th} control resource set, and further includes an index of the BWP corresponding to the control resource set. The BWP indicated by the index is the BWP corresponding to the control resource set. Different control resource sets may correspond to the same BWP or different BWPs. For example, BWP indexes carried in the configuration information of any two control resource sets may be identical or different.

Optionally, the information about the j^{th} control resource set includes information about a frequency-domain resource allocated to the j^{th} control resource set in the BWP corresponding to the j^{th} control resource set.

Further, optionally, the information about the j^{th} control resource set further includes information about a time-domain resource (also referred to as a search space) that is located in the j^{th} control resource set and used to monitor the PDCCH, for example, information about a slot or symbol that is used to monitor the PDCCH.

When the resource configuration information indicates the resource mapping relationship between the BWP and the control resource set by means of Form 2, optionally, before step 240, the terminal device may select, from the configuration information of the N control resource sets, at least one piece of configuration information that carries the index of the target BWP, and obtain, from the at least one piece of configuration information that carries the index of the target BWP, the information about the at least one control resource set corresponding to the target BWP.

For example, as shown in the schematic diagram of the BWP and the CORESET in FIG. 4, the resource configuration information includes configuration information of M BWPs and configuration information of N control resource sets. It is assumed that M=4 and N=11. The configuration information of the BWP 0 includes the information about the BWP 0, the configuration information of the BWP 1 includes the information about the BWP 1, the configuration information of the BWP 2 includes the information about the BWP 2, and the configuration information of the BWP 3 includes the information about the BWP 3.

Configuration information of a control resource set 0 includes an index (index 0) of a BWP to which the control resource set 0 belongs, and information about a frequency-domain resource that the control resource set 0 carries in the BWP indicated by the index 0. Configuration information of a control resource set 1 includes an index (index 1) of a BWP to which the control resource set 1 belongs, and information about a frequency-domain resource that the control resource set 1 carries in the BWP indicated by the index 1. Configuration information of a control resource set 2 includes an index (index 0) of a BWP to which the control resource set 2 belongs, and information about a frequency-domain resource that the control resource set 2 carries in the BWP indicated by the index 0. Configuration information of a control resource set 3 includes an index (index 2) of a BWP to which the control resource set 3 belongs, and information about a frequency-domain resource that the control resource set 3 carries in the BWP indicated by the index 2. Configuration information of a control resource set 4 includes an index (index 0) of a BWP to which the control resource set 4 belongs, and information about a frequency-domain resource that the control resource set 4 carries in the BWP indicated by the index 0. Configuration information of a control resource set 5 includes an index (index 0) of a BWP to which the control resource set 5 belongs, and information about a frequency-domain resource that the control resource set 5 carries in the BWP indicated by the index 0. Configuration information of a control resource set 6 includes an index (index 2) of a BWP to which the control resource set 6 belongs, and information about a frequency-domain resource that the control resource set 6 carries in the BWP indicated by the index 2. Configuration information of a control resource set 7 includes an index (index 3) of a BWP to which the control resource set 7 belongs, and information about a frequency-domain resource that the control resource set 7 carries in the BWP indicated by the index 3. Configuration information of a control resource set 8 includes an index (index 1) of a BWP to which the control resource set 8 belongs, and information about a frequency-domain resource that the control resource set 8 carries in the BWP indicated by the index 1. Configuration information of a control resource set 9 includes an index (index 2) of a BWP to which the control resource set 9 belongs, and information about a frequency-domain resource that the control resource set 9 carries in the BWP indicated by the index 2. Configuration information of a control resource set 10 includes an index (index 3) of a BWP to which the control resource set 10 belongs, and information about a frequency-domain resource that the control resource set 3 carries in the BWP indicated by the index 3.

In FIG. 4, the configuration information of each control resource set includes information about the control resource set and an index of a BWP corresponding to the control resource set. The index of the BWP in the configuration information of each control resource set indicates one of the M BWPs.

Assuming that an index of a target BWP currently used by the terminal device is a BWP 0, the terminal device selects, based on configuration information of the N CORESETs, the configuration information that carries an index 0 from such configuration information. As shown in FIG. 4, the configuration information that carries the index 0 includes the configuration information of a CORESET 0, a CORESET 1, a CORESET 2, and a CORESET 3. To be specific, at least one control resource set corresponding to the BWP indicated by the index 0 is the CORESET 0, the CORESET 1, the CORESET 2, and the CORESET 3. Therefore, the terminal device obtains the information about the BWP from the configuration information of the BWP indicated by the index 0, and monitors, in the CORESET 0, the CORESET 1, the CORESET 2, and the CORESET 3 that are located in the BWP, the PDCCH transmitted by the network device.

In this embodiment, the configuration information of the CORESET and the configuration information of the BWP are indicated by independent fields, and an index of a BWP corresponding to each CORESET is added to the configuration information of the CORESET. Compared with Form 1, this embodiment can configure the CORESET more flexibly.

Understandably, in this embodiment, the resource configuration information may include not only the configuration information of N control resource sets, but also configuration information of control resource sets other than the N control resource sets. For example, the resource configuration information further includes configuration information of at least one common control resource set, and the like. The configuration information of the common control resource set includes information about a frequency-domain resource (also referred to as a search space) allocated to the common control resource set, or may further include information about a symbol or slot that is used to monitor the PDCCH. The configuration information of the common control resource set may include, for example, information about a frequency-domain resource allocated to the common control resource set and may include no BWP index.

In Form 1, the resource mapping relationship between the BWP and the CORESET is embodied by an affiliation between the BWP and the CORESET. Specifically, the affiliation is implemented by adding information about the CORESET corresponding to the BWP to a dedicated field of the configuration information of the BWP.

In Form 2, the configuration information of the BWP is independent of the configuration information of the CORESET. The configuration information of the BWP normally indicates the BWP, but the configuration information of the CORESET not only includes the information about the frequency-domain resource allocated to the CORESET, but also indicates the index (or number) of the BWP corresponding to the CORESET.

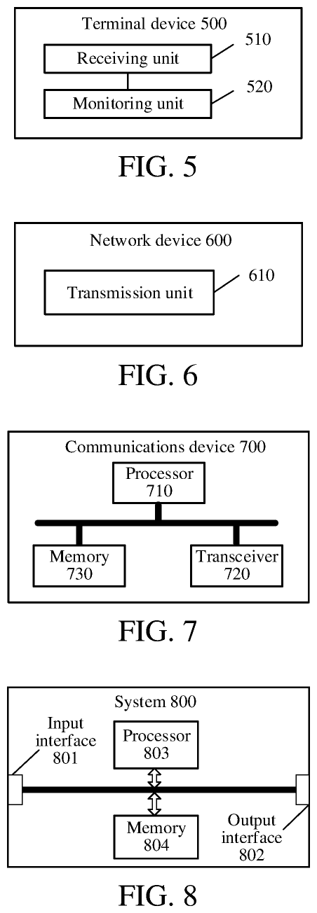

FIG. 5 is a schematic block diagram of a terminal device 500 according to an embodiment of this disclosure. As shown in FIG. 5, the terminal device 500 includes a receiving unit 510 and a monitoring unit 520.

The receiving unit 510 is configured to receive resource configuration information transmitted by a network device, where the resource configuration information is used to indicate resource mapping relationships between M bandwidth parts (BWPs) and N control resource sets, and M and N are positive integers.

The monitoring unit 520 is configured to monitor, based on the resource mapping relationships, a physical downlink control channel (PDCCH) transmitted by the network device over at least one control resource set corresponding to a target BWP used by the terminal device.

Therefore, when dynamic switching occurs between a plurality of BWPs used by the terminal device, the network device may transmit the PDCCH by using different control resource sets. Accordingly, the terminal device monitors the PDCCH over a control resource set corresponding to a currently used BWP, thereby enabling flexible transmission of the PDCCH over different frequency-domain resources, improving transmission efficiency, and reducing power consumption of the terminal device.

Optionally, the resource configuration information includes configuration information of each of the M BWPs, and configuration information of the i^{th} BWP in the M BWPs includes information about the i^{th} BWP and information about at least one control resource set corresponding to the i^{th} BWP, where i ranges from 0 to M−1.

Optionally, the terminal device further includes a processing unit, configured to obtain, from configuration information of the target BWP, information about the at least one control resource set corresponding to the target BWP.

Optionally, information about each control resource set of the at least one control resource set corresponding to the i^{th} BWP includes information about a frequency-domain resource allocated to each control resource set in the i^{th} BWP.

Optionally, the information about each control resource set of the at least one control resource set corresponding to the i^{th} BWP further includes information about a time-domain resource that is located in each control resource set and used to monitor the PDCCH.

Optionally, the information about the time-domain resource includes information about a slot or symbol that is used to monitor the PDCCH.

Optionally, the resource configuration information includes configuration information of each of the M BWPs and configuration information of each of the N control resource sets, where configuration information of the i^{th} BWP in the M BWPs includes information about the i^{th} BWP, and configuration information of the j^{th} control resource set in the N control resource sets includes information about the j^{th} control resource set and an index of a BWP corresponding to the j^{th} control resource set, where i ranges from 0 to M−1, and j ranges from 0 to N−1.

Optionally, the terminal device further includes a processing unit, configured to: select, from the configuration information of the N control resource sets, at least one piece of configuration information that carries an index of the target BWP, and obtain, from the at least one piece of configuration information that carries the index of the target BWP, information about the at least one control resource set corresponding to the target BWP.

Optionally, the information about the j^{th} control resource set includes information about a frequency-domain resource allocated to the j^{th} control resource set in the BWP corresponding to the j^{th} control resource set.

Optionally, the information about the j^{th} control resource set further includes information about a time-domain resource that is located in the j^{th} control resource set and used to monitor the PDCCH.

Optionally, the information about the time-domain resource includes information about a slot or symbol that is used to monitor the PDCCH.

Understandably, the terminal device 500 may perform corresponding operations that are performed by a terminal device in the method 200. For brevity, the detailed description thereof is omitted herein.

FIG. 6 is a schematic block diagram of a network device 600, according to an embodiment of this disclosure. As shown in FIG. 6, the network device 600 includes a transmission unit 610, configured to transmit resource configuration information to a terminal device, where the resource configuration information is used to indicate resource mapping relationships between M bandwidth parts (BWPs) and N control resource sets, and M and N are positive integers.

Therefore, when dynamic switching occurs between a plurality of BWPs used by the terminal device, the network device may transmit the PDCCH by using different control resource sets. Accordingly, the terminal device monitors the PDCCH over a control resource set corresponding to a currently used BWP, thereby enabling flexible transmission of the PDCCH over different frequency-domain resources, improving transmission efficiency, and reducing power consumption of the terminal device.

Optionally, the transmission unit 610 is further configured to: transmit a physical downlink control channel (PDCCH) to the terminal device over at least one control resource set corresponding to a target BWP used by the terminal device.

Optionally, the resource configuration information includes configuration information of each of the M BWPs, and configuration information of the i^{th} BWP in the M BWPs includes information about the i^{th} BWP and information about at least one control resource set corresponding to the i^{th} BWP, where i ranges from 0 to M−1.

Optionally, information about each control resource set of the at least one control resource set corresponding to the i^{th} BWP includes information about a frequency-domain resource allocated to each control resource set in the i^{th} BWP.

Optionally, the information about each control resource set of the at least one control resource set corresponding to the i^{th} BWP further includes information about a time-domain resource that is located in each control resource set and used to transmit the PDCCH.

Optionally, the information about the time-domain resource includes information about a slot or symbol that is used to transmit the PDCCH.

Optionally, the resource configuration information includes configuration information of each of the M BWPs and configuration information of each of the N control resource sets, where configuration information of the i^{th} BWP in the M BWPs includes information about the i^{th} BWP, and configuration information of the j^{th} control resource set in the N control resource sets includes information about the j^{th} control resource set and an index of a BWP corresponding to the j^{th} control resource set, where i ranges from 0 to M−1, and j ranges from 0 to N−1.

Optionally, the information about the j^{th} control resource set includes information about a frequency-domain resource allocated to the j^{th} control resource set in the BWP corresponding to the j^{th} control resource set.

Optionally, the information about the j^{th} control resource set further includes information about a time-domain resource that is located in the j^{th} control resource set and used to transmit the PDCCH.

Optionally, the information about the time-domain resource includes information about a slot or symbol that is used to transmit the PDCCH.

Understandably, the network device 600 may perform corresponding operations that are performed by a network device in the method 200. For brevity, the detailed description thereof is omitted herein.

FIG. 7 is a schematic structural diagram of a communications device 700 according to an embodiment of this disclosure. As shown in FIG. 7, the communications device includes a processor 710, a transceiver 720, and a memory 730. The processor 710, the transceiver 720, and the memory 730 communicate with each other through an internal connection path. The memory 730 is configured to store an instruction. The processor 710 is configured to execute the instruction stored in the memory 730 to control the transceiver 720 to receive or transmit a signal.

Optionally, the processor 710 may invoke program code stored in the memory 730 to perform corresponding operations that are performed by a terminal device in the method 200. For brevity, the detailed description thereof is omitted herein.

Optionally, the processor 710 may invoke program code stored in the memory 730 to perform corresponding operations that are performed by a network device in the method 200. For brevity, the detailed description thereof is omitted herein.

It should be understood that the processor of this embodiment of this disclosure may be an integrated circuit chip and has a signal processing capability. During implementation, the steps of the foregoing method embodiment may be implemented by using a hardware integrated logic circuit in the processor or implemented by using an instruction in a software form. The foregoing processor may be a general-purpose processor, a digital signal processor (DSP), an application-specific integrated circuit (ASIC), a field programmable gate array (FPGA), or another programmable logic device, discrete gate or transistor logical device, or discrete hardware component. The processor may implement or perform methods, steps and logical block diagrams disclosed in the embodiments of this disclosure. The general-purpose processor may be a microprocessor, or the processor may be any conventional processor and the like. Steps of the methods disclosed with reference to the embodiments of this disclosure may be directly executed and completed by means of a hardware decoding processor, or may be executed and completed by using a combination of hardware and software modules in the decoding processor. The software module may be located in a mature storage medium in the field, such as a random-access memory, a flash memory, a read-only memory, a programmable read-only memory, an electrically-erasable programmable memory, or a register. The storage medium is located in the memory, and the processor reads information in the memory and completes the steps in the foregoing methods in combination with hardware of the processor.

It can be understood that, the memory in the embodiments of this disclosure may be a volatile memory or a non-volatile memory or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM), and is used as an external cache. Through exemplary but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM) and a direct rambus random access memory (DR RAM). It should be noted that, the memory for the system and the method described in this disclosure aims to include but not limited to these memories and any other suitable types of memories.

FIG. 8 is a schematic structural diagram of a system according to an embodiment of this disclosure. The system 800 in FIG. 8 includes an input interface 801, an output interface 802, at least one processor 803, and a memory 804. The input interface 801, the output interface 802, the processor 803, and the memory 804 are interconnected through an internal connection path. The processor 803 is configured to execute code in the memory 804. The system 800 may be implemented as one or more chips.

Optionally, when the code is executed, the processor 803 may implement corresponding operations that are performed by a terminal device in the method 200. For brevity, the detailed description thereof is omitted herein.

Optionally, when the code is executed, the processor 803 may implement corresponding operations that are performed by a network device in the method 200. For brevity, the detailed description thereof is omitted herein.

It should be understood that in this embodiment of the present disclosure, “B corresponding to A” indicates that B is associated with A, and B may be determined based on A. However, it should further be understood that determining B according to A does not mean that B is determined according to A only; that is, B may alternatively be determined according to A and/or other information.

It is understood that, in combination with the examples described in the embodiments disclosed in this specification, units and algorithm steps may be implemented by electronic hardware, or a combination of computer software and electronic hardware. Whether the functions are performed by hardware or software depends on particular applications and design constraint conditions of the technical solutions. Different methods may be used to implement the described functions for each particular application, but it should not be considered that the implementation goes beyond the scope of this disclosure.

It may be understood that, for the purpose of convenient and brief description, for a detailed working process of the foregoing system, apparatus, and unit, refer to a corresponding process in the foregoing method embodiments, and details are not described herein again.

In the several embodiments provided in this disclosure, it should be understood that the disclosed system, apparatus, and method may be implemented in other manners. For example, the described apparatus embodiments are merely schematic. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of this disclosure may be integrated into one unit (for example, a monitoring unit in the case of a terminal device), or each of the units may exist alone physically, or two or more units are integrated into one unit.

When the functions are implemented in a form of a software functional module and sold or used as an independent product, the functions may be stored in a computer-readable storage medium. Based on such an understanding, the technical solutions of this disclosure may be implemented in the form of a software product. The computer software product is stored in a storage medium, and includes several instructions for instructing a computer device (which may be a personal computer, a server, a network device, and the like) to perform all or a part of the steps of the method described in the embodiments of this disclosure. The foregoing storage medium includes any medium that can store program codes, such as a USB flash disk, a removable hard disk, a read-only memory (ROM), a random access memory (RAM), a magnetic disk, or an optical disk.

The foregoing descriptions are merely specific implementation manners of this disclosure but are not intended to limit the protection scope of this disclosure. Any variation or replacement readily within the technical scope disclosed in this disclosure shall fall within the scope of this disclosure.

What is claimed is:

1. A terminal device in a communication network, comprising:
a processor; and
a memory storing code,
wherein the processor is configured to, when the code is running, cause the terminal device at least to:
obtain resource configuration information, wherein the resource configuration information indicates resource mapping relationships between M bandwidth parts (BWP) sand N control resource sets, where M and N are positive integers; and
monitor, based on the resource mapping relationships, a physical downlink control channel (PDCCH) at least one control resource set corresponding to a target BWP used by the terminal device.

2. The terminal device according to claim 1, wherein the resource configuration information comprises configuration information of each of the M BWPs, and a configuration information of the i^{th} BWP in the M BWPs comprises information about the i^{th} BWP and information about at least one control resource set corresponding to the i^{th} BWP, where i ranges from 0 to M−1.

3. The terminal device according to claim 2, wherein the processor is further configured to, when the code is running, cause the terminal device at least to obtain, from configuration information of the target BWP, information about the at least one control resource set corresponding to the target BWP.

4. The terminal device according to claim 2, wherein information about each control resource set of the at least one control resource set corresponding to the i^{th} BWP comprises information about a frequency-domain resource allocated to each control resource set in the i^{th} BWP.

5. The terminal device according to claim 4, wherein the information about each control resource set of the at least one control resource set corresponding to the i^{th} BWP further comprises information about a time-domain resource that is located in each control resource set and used to monitor the PDCCH.

6. The terminal device according to claim 2, wherein the information about each control resource set of the at least one control resource set corresponding to the i^{th} BWP further comprises information about a control resource set (CORESET) corresponding to the i^{th} BWP.

7. The terminal device according to claim 5, wherein the information about the time-domain resource comprises information about a symbol that monitors the PDCCH.

8. The terminal device according to claim 1, wherein
the resource configuration information comprises configuration information of each of the M BWPs and configuration information of each of the N control resource sets; and
configuration information of the i^{th} BWP in the M BWPs comprises information about the i^{th} BWP, and configuration information of the j^{th} control resource set in the N control resource sets comprises information about the j^{th} control resource set and an index of a BWP corresponding to the j^{th} control resource set, where i ranges from 0 to M−1, and j ranges from 0 to N−1.

9. A network device in a communication network, comprising:
a processor; and
a memory storing code,
wherein the processor is configured to, when the code is running, cause the network device at least to:
provide resource configuration information, wherein the resource configuration information indicates resource mapping relationships between M bandwidth parts (BWPs) and N control resource sets, where M and N are positive integers; and
output the resource configuration information to a terminal device.

10. The network device according to claim 9, wherein the processor is further configured to, when the code is running, cause the network device at least to output a physical downlink control channel (PDCCH) over at least one control resource set corresponding to a target BWP used by the terminal device.

11. The network device according to claim 9, wherein the resource configuration information comprises configuration information of each of the M BWPs, and the configuration information of the i^{th} BWP in the M BWPs comprises information about the i^{th} BWP and information about at least one control resource set corresponding to the i^{th} BWP, wherein i ranges from 0 to M−1.

12. The network device according to claim 11, wherein information about at least one control resource set corresponding to the configuration information of the i^{th} BWP is carried in a dedicated field of the i^{th} BWP.

13. The network device according to claim 11, wherein information about each control resource set of the at least one control resource set corresponding to the i^{th} BWP comprises information about a frequency-domain resource allocated to each control resource set in the i^{th} BWP.

14. The network device according to claim 13, wherein the information about each control resource set of the at least one control resource set corresponding to the i^{th} BWP further comprises information about a time-domain resource that is located in each control resource set and used to transmit the PDCCH.

15. The network device according to claim 11, wherein the information about each control resource set of the at least one control resource set corresponding to the i^{th} BWP further comprises information about a control resource set (CORESET) corresponding to the i^{th} BWP.

16. The network device according to claim 14, wherein the information about the time-domain resource comprises information about a symbol that transmits the PDCCH.

17. A method for configuring resource, comprising:
obtaining, by a terminal device, resource configuration information transmitted by a network device, wherein the resource configuration information indicates resource mapping relationships between M bandwidth parts (BWPs) and N control resource sets, where M and N are positive integers; and
monitoring, by the terminal device, based on the resource mapping relationships, a physical downlink control channel (PDCCH) over at least one control resource set corresponding to a target BWP used by the terminal device.

18. The method according to claim 17, wherein the resource configuration information comprises configuration information of each of the M BWPs, and a configuration information of the i^{th} BWP in the M BWPs comprises information about the i^{th} BWP and information about at least one control resource set corresponding to the i^{th} BWP, where i ranges from 0 to M−1.

19. The method according to claim 18, wherein the method further comprises:
obtaining, from configuration information of the target BWP, information about the at least one control resource set corresponding to the target BWP.

20. The method according to claim 18, wherein information about each control resource set of the at least one control resource set corresponding to the i^{th} BWP comprises information about a frequency-domain resource allocated to each control resource set in the i^{th} BWP.

21. The method according to claim 18, wherein the information about each control resource set of the at least one control resource set corresponding to the i^{th} BWP further comprises information about a control resource set (CORESET) corresponding to the i^{th} BWP.

22. The method according to claim 20, wherein the information about the time-domain resource comprises information about a symbol that monitors the PDCCH.

23. A method for configuring resource, comprising:
providing, by a network device, resource configuration information, wherein the resource configuration information indicates resource mapping relationships between M bandwidth parts (BWPs) and N control resource sets, where M and N are positive integers; and
outputting, by the network device, the resource configuration information to a terminal device.

24. The method according to claim 23, wherein the method further comprises:
outputting, by the network device, a physical downlink control channel (PDCCH) over at least one control resource set corresponding to a target BWP used by the terminal device.

25. The method according to claim 23, wherein the resource configuration information comprises configuration information of each of the M BWPs, and the configuration information of the i^{th} BWP in the M BWPs comprises information about the i^{th} BWP and information about at least one control resource set corresponding to the i^{th} BWP, wherein i ranges from 0 to M−1.

26. The method according to claim 25, wherein information about each control resource set of the at least one control resource set corresponding to the i^{th} BWP comprises information about a frequency-domain resource allocated to each control resource set in the i^{th} BWP.

27. The method according to claim 25, wherein the information about each control resource set of the at least one control resource set corresponding to the i^{th} BWP further comprises information about a time-domain resource that is located in each control resource set and used to transmit the PDCCH.

28. The method according to claim 25, wherein the information about each control resource set of the at least one control resource set corresponding to the i^{th} BWP further comprises information about a control resource set (CORESET) corresponding to the i^{th} BWP.

29. The method according to claim 27, wherein the information about the time-domain resource comprises information about a symbol that transmits the PDCCH.
